(19) United States
(12) Patent Application Publication
(10) Pub. No.: US 2010/0231471 A1
(43) Pub. Date: Sep. 16, 2010

(54) Antenna for Use Close to a Semi-Conducting Material

(75) Inventor: Arild Haglund, Grimstad (NO)

Correspondence Address: ANDRUS, SCEALES, STARKE & SAWALL, LLP, 100 EAST WISCONSIN AVENUE, SUITE 1100, MILWAUKEE, WI, 53202, US

(73) Assignee: Wireless Patient Recording Medical AS

(21) Appl. No.: 12/678,683

(22) PCT Filed: Sep. 17, 2008
(86) PCT No.: PCT/NO08/00332

§ 371 Date: May 19, 2010

(30) Foreign Application Priority Data
Sep. 20, 2007 (NO) 20074794

(51) Int. Cl. H01Q 1/00; H01Q 7/00

(52) U.S. Cl. 343/729; 343/748

(57) ABSTRACT

An antenna for use near a semi-conducting material, such as at a living body, the antenna comprising a first portion and a second portion, the first portion being constituted by a whip antenna and the second portion being constituted by a loop antenna.

This invention relates to an antenna for use near a semiconducting material. More particularly, it relates to an antenna for use near a semiconducting material, such as at a living body, the antenna including a first portion and a second portion, the first portion being constituted by a whip antenna and the second portion being constituted by a loop antenna.

By a semiconducting material is meant, in this connection, a body which cannot be described as electrically conductive, nor as an isolator. A body may be constituted by a liquid, an elastic material or a solid material, and is illustrated below with reference to the human body. This reference does not in any way limit the range of application of the antenna.

During wireless transmission of measurement signals from measurement equipment which is placed at a person's or an animal's skin, antenna-dependent variations may occur which cause the signal transmission to be disturbed or, at worst, to stop.

The condition is connected to the fact that in such equipment it is usually necessary to use relatively small antennas which are sensitive to changes in distance, for example to their ground planes. The ground plane is constituted, when the antenna is near the body, at least partially by the tissues of the body.

Common antenna theory would suggest the use of for example a whip antenna with a length of ¼ or ⅝ wavelength at the frequency of interest. A ⅝-wavelength antenna is preferable because it is less affected by the surroundings than a quarter-wavelength antenna.

When used in, for example, a wireless instrument for measuring ECG signals, by which the instrument is adhered to the skin, and by which the instrument transfers the signals at 2.4 GHz, the antenna will need to be 7.8 cm long. Such a length is considerably larger than the space available and therefore incompatible with the size of the relevant printed circuit boards of an instrument of this kind.

Another possibility is to use a substantially smaller tuned whip antenna or a so-called loop antenna. (The English term loop is used in what follows because the Norwegian term “ram-meantenne” (frame antenna) is less established among professionals.)

However, the band width of the antenna is reduced with reduced antenna size, while at the same time the resonant frequency is very sensitive to changes in the surroundings, which entails that the antenna may easily be detuned, which means that the resonant frequency of the antenna is moved away from the transmitter frequency.

For these types of antenna, relatively small variations in the distance from the skin may lead to an unacceptable change in resonant frequency.

The invention has for its object to remedy or reduce at least one of the drawbacks of the prior art.

The object is achieved according to the invention through the features which are specified in the description below and in the claims that follow.

An antenna in accordance with the invention for use near a semiconducting material, such as at a living body, the antenna including a first portion and a second portion, is characterized by the first portion being constituted by a whip antenna and the second portion being constituted by a loop antenna.

Trials with small antennas have shown that the resonant frequency of a pure whip antenna falls when it is placed nearer to a person's body, whereas the resonant frequency of a loop antenna increases when it is placed nearer to the body.

A whip antenna is an asymmetric antenna which is dependent on a ground plane to work satisfactorily. If a whip antenna is shorter than a quarter of a wavelength, the whip antenna will exhibit a capacitance and must therefore be tuned in a manner known per se by means of an inductance in series, which causes the band width to be reduced in relation to that of a quarter-wave whip antenna. The electrical field, the E field, is dominant in the near field of the whip antenna.

The capacitance of the whip antenna is dependent on the length of the whip antenna and conditions like antenna wire dimension or antenna track width on a printed circuit board, and also distance to the ground plane. If the whip antenna is placed near a conductive or semiconducting material, such as a human body, the capacitance will increase because the effective distance to the ground plane is reduced. This results in the resonant frequency falling.

The resonant frequency of a whip antenna is given by the formula:

frp=(2π(Lp*Cp)^{1/2})⁻¹

in which Lp is the inductance of the whip antenna, which is constant, and Cp is the capacitance of the whip antenna. When the whip antenna is formed by a track on a board, the capacitance Cp will be determined by the total surface, length by width that is, of the whip antenna towards the body and its distance to it.

A loop antenna is an inductive antenna and normally needs tuning to achieve resonance at the desired frequency. The tuning is carried out by providing a capacitance which is connected in parallel or series to the loop antenna. In the near field of the loop antenna, the magnetic field, the B-field, is dominant.

When a loop antenna is placed near a semiconducting body, and parallel to it, a current will be induced in the semiconducting body, the current reducing the total magnetic flux in the loop antenna. This causes the inductance in the loop antenna to be reduced, whereby the resonant frequency of the loop antenna increases. The degree of reduction in inductance is determined by the area of the loop antenna, the distance to the semiconducting body and the conductivity of the body.

The resonant frequency of a loop antenna is given by the formula:

frl=(2π(Ll*Cl)^{1/2})⁻¹

in which Ll is the inductance of the loop antenna, and Cl is the tuning capacitance of the loop antenna.

The conductivity of the body is determined mainly by the content of salt which is fairly similar from individual to individual. Thus, the inductance Ll of the loop antenna and thereby the resonant frequency change equally, independently of the person or the animal at which it is placed.

When the whip antenna and loop antenna are connected to each other, see for example the particular part of the description, the antenna exhibits a parallel C-L resonance. The resonant frequency is given by the formula:

fr=(2π(Ll*Cp)^{1/2})^{31 1}

in which, as above, Ll is the inductance of the loop antenna and Cp is the capacitance of the whip antenna referring to the point of connection.

By tuning the track width and length of the whip antenna to the loop area of the loop antenna, the inductance of the loop antenna is changed to the same degree as the capacitance of the whip antenna, but in the opposite direction, when the antenna is parallel to the surface of the body and the distance to the body is changed. That is to say, the product Ll*Cp remains approximately unchanged, whereby also the resonant frequency of the antenna is changed only to an insignificant degree.

Normally there is also a permanent ground plane relatively near the whip antenna. The value Cp mentioned refers to the part of the ground plane constituted by the body.

However, the antenna is not as effective when it is near the body as when it is in a free space. The cause of this is that radiation resistance and loss resistance are changed. For small antennas this change has little effect in relation to so-called detuning, deviations from resonant frequency, with a view to the efficiency of the antenna because small antennas have small bandwidths.

The tuning depends, in the main, only on the conductivity of the material near which the antenna is to be used and may, in principle, be adjusted to all frequencies.

Calculation of the tuning of the whip and loop antenna can be carried out by using an antenna-calculation program and is verified by means of a vector network analyser.

The combination of a whip antenna and a loop antenna according to the invention provides a solution which essentially overcomes the problem of detuning near a semiconducting body or a liquid.

In what follows, is described a non-limiting example of a preferred embodiment which is visualized in the accompanying drawing, in which:

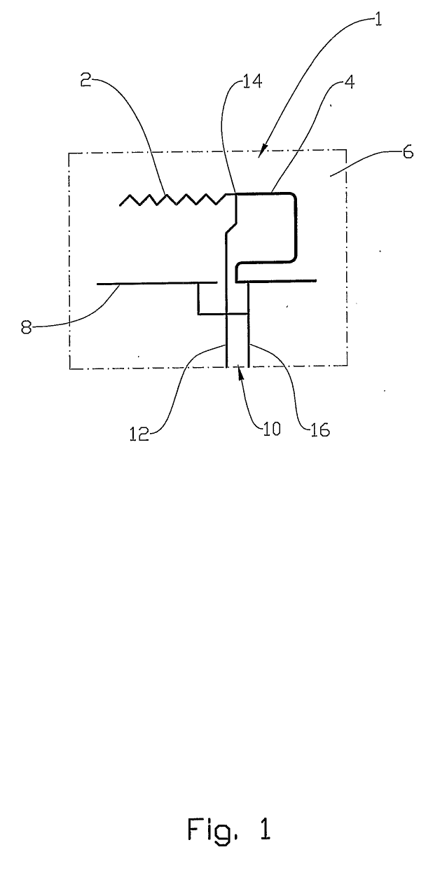

FIG. 1 shows an antenna in accordance with the invention.

In the drawing the reference numeral 1 indicates an antenna comprising a whip antenna 2 and a loop antenna 4.

The antenna 1 is formed as a circuit on a printed circuit board 6 and is provided with a permanent ground plane 8. The whip antenna 2 and loop antenna 4 are fed from a conductor pair 10 via a feed track 12 to a common feed point 14 and a grounding track 16 which is connected to the opposite phase of the loop antenna 4 and to the permanent ground plane 8, which may, if desired, be on an adjacent board.

The antenna in FIG. 1, which is on a somewhat enlarged scale, is calculated according to the principles in the general part of the description for a resonant frequency of 2.4 GHz. It may be mentioned that the length of the antenna 1 adapted to this frequency, the length being the sum of the length of the whip antenna 2 and the extent of the loop antenna 4 in the same direction, is 22 mm in total.

1. An antenna (1) for use near a semiconducting material, such as at a living body, the antenna (1) comprising a first portion and a second portion, characterized in that the first portion is constituted by a whip antenna (2) and the second portion is constituted by a loop antenna (4).

2. The antenna in accordance with claim 1, characterized in that the whip antenna (2) and loop antenna (4) are tuined in such a way that the resulting resonant frequency of the antenna (1) is substantially constant as the distance of the antenna (1) to the semiconducting body is changed.

3. The antenna in accordance with claim 1, characterized in that the whip antenna (2) is tuned to the loop antenna (4) in such a way that the inductance of the loop antenna (4) is changed to the same extent as the capacity of the whip antenna (2), but in the opposite direction, when the antenna (1) is parallel with the surface of the semiconducting material and the distance to the semiconducting material is changed.

4. The antenna in accordance with claim 1, characterized in that the track width and length of the whip antenna (2) are tuned to the loop area of the loop antenna (4), whereby the inductance of the loop antenna (4) is changed to the same extent as the capacitance of the whip antenna (2), but in the opposite direction, when the antenna (1) is parallel to the surface of the semiconducting body and the distance to the semiconducting body is changed.

5. The antenna in accordance with claim 1, characterized in that the whip antenna (2) and loop antenna (4) have a common feed point (14).

6. The antenna in accordance with claim 1, characterized in that the whip antenna (2) has a permanent ground plane (8) in addition to the semiconducting body.
